(19) United States
(12) Patent Application Publication
(10) Pub. No.: US 2004/0004458 A1
(43) Pub. Date: Jan. 8, 2004

(54) Charging control circuit, charger, power supply circuit, information processing device, and battery pack

(75) Inventors: Shigeo Tanaka, Kawasaki (JP); Hidekiyo Ozawa, Kasugai (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/460,473

(22) Filed: Jun. 13, 2003

(30) Foreign Application Priority Data
Jul. 4, 2002 (JP) 2002-195876

(51) Int. Cl. H02J 7/00

(52) U.S. Cl. 320/106

(57) ABSTRACT

A power supply circuit, a charger, a charging control circuit, an information processing device and a battery pack are provided which is capable of decreasing electric current detection resistors at a charger side thereby to achieve improvements in the charging efficiency of a power supply circuit or the like as well as reduction in cost and size. A charging current flows in a current sensing resistor RS arranged in a battery pack 4A upon charging thereof. A charging control circuit 8A detects the charging current by detecting a voltage across opposite ends of the current sensing resistor RS, and controls the charging current by using the detection value thereof in such a manner that the charging current is in a prescribed range. As a result, the number of current detection resistors, which are employed in one closed circuit formed in a power supply circuit 1A upon charging, can be made one.

### BACKGROUND OF THE INVENTION

1. Field of the Invention

The present invention relates to a power supply circuit provided with a battery, a charger for charging the battery, a charging control circuit for controlling the charger, an information processing device provided with a power supply circuit, and a battery pack having the battery received therein. More particularly, it relates to such a power supply circuit, a charger, a charging control circuit, an information processing device, and a battery pack in which a current sensing resistor arranged in the battery pack for prevention of an overcurrent is shared as a resistor used for detecting a charging current of the charger.

2. Description of the Related Art

Portable electronic equipment (information processing device) such as a notebook personal computer or the like has a battery incorporated therein as a power supply for such equipment. For this battery, there has generally been used a rechargeable battery such as a lithium ion (Li+) battery for the purposes of reducing the operational cost of the equipment, securing a current capacity capable of being discharged momentarily, etc. In addition, such electronic equipment is provided with a charger for charging the rechargeable battery, so that the rechargeable battery can be easily charged merely by connecting the electronic equipment to an AC power source through an AC adapter. Since it is common that such electronic equipment is used while being carried by a user, the rechargeable battery built in the electronic equipment is usually used as a power supply for the equipment. However, when the electronic equipment is used on a desk, it can be operated by electric power supplied from an external power supply through an AC adapter or the like.

Lithium ion (Li+) batteries, NiMH (nickel metal hydride) rechargeable batteries, etc., are known as rechargeable batteries frequently used with portable equipment such as notebook personal computers. When a rechargeable battery is charged, a positive terminal of the rechargeable battery is connected with a positive terminal side of a power supply circuit, and a negative terminal of the rechargeable battery is connected with a negative terminal side of the power supply circuit, so that the rechargeable battery is charged by being supplied with electric current from the power supply circuit. In this case, it is necessary to control the electric current in such a manner that the current flows into the battery at a constant rate.

The charging of an NiMH battery is carried out with a constant charging current, but in case of a lithium ion rechargeable battery, charging is performed by a constant voltage and a constant current so that the charging voltage in addition to the charging current can be made constant so as not to exceed a prescribed voltage level. In order to make the charging current at a prescribed constant level, it is general practice that a current detection resistor (hereinafter referred to as a charging current detection resistor) is connected to an output side of a charging circuit for detecting an output current thereof, so that a voltage drop due to the current flowing through the resistor is measured to control the charging current.

FIG. 3 is a block diagram that shows a known power supply circuit of a PC (personal computer) system or the like using a rechargeable battery as a power supply. The power supply circuit 1 includes a charger 3 adapted to be connected with an AC adapter for obtaining a DC power supply for charging, a battery pack 4 connected with the charger 3 and provided with battery cells E1, E2 and E3 (hereinafter simply referred to as a rechargeable battery) that together constitute a rechargeable battery, and a converter part 5 for converting a DC voltage obtained from the rechargeable battery into voltages of desired levels to supply them to appropriate portions of an unillustrated PC system.

The charger 3 is provided, as connector terminals, with a power supply input terminal 3a adapted to be connected with an output terminal 2a of an AC adapter 2, a first connection terminal 3b connected with a positive terminal side of the rechargeable battery, and a second connection terminal 3c and a third connection terminal 3d connected with a negative terminal side of the rechargeable battery. Also, the charger 3 is further provided with a charging circuit 6 connected between the power supply input terminal 3a and the first connection terminal 3b, and a connection state determination part 7 connected with the third connection terminal 3d for determining and detecting the connection state of the battery pack 4. The second connection terminal 3c of the charger 3 is connected with the earth.

As shown in detail in FIG. 4, the charging circuit 6 is provided with a switching transistor FET1, a choke coil L1 and a charging current detection resistor R1 all connected in series with a charging current supply line formed between the power supply input terminal 3a (see FIG. 3) and the first connection terminal 3b. The charging circuit 6 is further provided with a charging control circuit 8 for charging the rechargeable battery in a prescribed voltage range and in a prescribed current range by turning on and off the switching transistor FET1, and a flywheel synchronous rectifier switch in the form of a transistor FET2 for discharging the electric power of the choke coil L1.

The charging control circuit 8 includes a first comparator AMP1 in the form of a voltage amplifier for obtaining a potential difference between potentials at the opposite ends of the charging current detection resistor R1, a second comparator ERA1 in the form of a current control error amplifier for comparing the potential difference obtained by the first comparator AMP1 with a first prescribed potential (reference potential) e1, a third comparator ERA2 in the form of a voltage control error amplifier for comparing a potential at the first connection terminal 3b side of the charging current detection resistor R1 with a second prescribed potential (reference potential) e2, a PWM (pulse width modulator) 9 for controlling to turn on and off the switching transistor FET1 based on the comparison results of the second comparator ERA1 and the third comparator ERA2 in such a manner that the charging voltage and the charging current are held within the prescribed voltage range and the prescribed current range, respectively, and a charging control circuit power supply part 10a for providing a power supply to the charging control circuit 8.

The PWM 9 is provided with a triangular wave generation circuit 9a in the form of a triangular wave oscillator, as is well known, which outputs a train of pulses having a pulse width modulated based on the comparison results of the comparators ERA1, ERA2. Here, note that the PWM 9 turns on and off the flywheel synchronous rectifier switch (transistor) FET2 at prescribed timing in accordance with its output pulses to discharge the choke coil L1. With the above-mentioned configuration, the second comparator ERA1 outputs a low voltage when the electric current flowing through the charging current detection resistor R1 exceeds a predetermined allowable value, and outputs a high voltage when the predetermined allowable value is not exceeded.

The connection state determination part 7 is provided with a comparator COMP in the form of a voltage comparator for comparing a potential at the third connection terminal 3d with a prescribed potential (reference potential) e0, a power management microcomputer 10 for determining the comparison result of the comparator COMP, and a resistor R0 connected between the third connection terminal 3d and a power supply voltage Vcc. The reference voltage e0 is given to a non-inverting input of the comparator COMP. Thus, when the battery pack 4 is not installed onto or attached to the charger 3, the third connection terminal 3d is connected with the power supply voltage Vcc through the resistor R0, so that the voltage Vcc is input to an inverting input of the comparator COMP. Since the voltage Vcc is higher than the reference voltage e0, the comparator COMP generates an output of a low level, thus indicating that the battery pack 4 is not connected with the charger 3.

When the battery pack 4 is installed onto or attached to the charger 3, the third connection terminal 3d is connected with ground through a circuit in the battery pack 4. Therefore, the potential at the third connection terminal 3d becomes a ground potential, which is applied to the inverting input of the comparator COMP. Since the ground potential is lower than the reference voltage e0, the comparator COMP generates an output of a high level, thus indicating that the battery pack 4 is installed on the charger 3. The power management microcomputer 10 observes or monitors the state of the battery pack 4 and the connection state of the AC adapter 2 based on the comparison result of the comparator COMP. Alternatively, it monitors the start and end of charging of the battery, as well as the state of the residual or remaining quantity of the battery. For instance, when the battery pack 4 is detached or removed from the charger 3, the power supplied to the charging control circuit 8 by the charging control circuit power supply part 10a is stopped, whereby the charging operation of the charger 3 is stopped.

The battery pack 4 is provided with a first external connection terminal (+ terminal) 4a, a second external connection terminal (− terminal) 4b, and a third external connection terminal (attaching/detaching detection terminal) 4c, which are connected with the first through third connection terminals 3b-3d, respectively, of the charger 3. Switching transistors FET11, FET12, the battery cells E1, E2, E3 of the rechargeable battery and a current sensing resistor RS are connected in series between the first external connection terminal 4a and the second or third external connection terminal 4b or 4c. Moreover, a protection circuit 13 detects the residual or remaining quantity of each of the battery cells E1, E2 and E3 of the rechargeable battery. In addition, the protection circuit 13 also detects an overdischarge state based on a potential difference across the opposite ends of the current sensing resistor RS thereby to turn off the switching transistors FET11, FET12.

Here, note that the converter part 5 shown in FIG. 3 is provided with a selector 14 for selecting between when the electronic equipment is powered from the AC adapter 2 and when the electronic equipment is powered from the rechargeable battery E1, E2 and E3, and a plurality of voltage converters 15 for converting the selected power supply electric power into desired voltages, respectively, to supply them to respective locations of the electronic equipment.

With the known power supply circuit 1 and charger 3 as constructed above, upon charging of the rechargeable battery E1, E2 and E3, a charging current flows into the battery pack 4 through the charging current detection resistor R1 and the first connection terminal 3b of the charger 3. Further, the charging current returns to the second connection terminal 3c of the charger 3 while flowing through the rechargeable battery E1, E2, E3 and the current sensing resistor RS, whereby the rechargeable battery is charged. At this time, the charging current is detected by the use of the charging current detection resistor R1, and the current value thus detected is observed or monitored by the charging control circuit 8. On the other hand, when the rechargeable battery E1, E2 and E3 discharges during use of the electronic equipment, a discharging current is detected by using the current sensing resistor RS, and an overcurrent state of the electronic equipment is observed or monitored by the protection circuit 13 based on the current value thus detected.

Incidentally, the charging time of the rechargeable battery depends on the magnitude of the charging current, so under the demand that the battery is wanted to be charged in a short time or the battery capacity is wanted to be increased, there arises the necessity of throwing a large current into the charging current detection resistor R1, thus making it unavoidable to increase the size of this resistor. Moreover, it is necessary to detect the charging current with a high degree of accuracy, and hence the charging current detection resistor R1 always becomes expensive. Furthermore, when a large current flows through the resistor, a power loss due to the resistance of the resistor becomes large, too.

On the other hand, the protection circuit (or overdischarge prevention circuit) 13 incorporated in the battery pack 4 monitors whether the rechargeable battery is short-circuited or charged by an excessive electric current by mistake, by using the current sensing resistor RS to detect a potential difference (voltage drop) across the opposite ends thereof. However, such a current sensing resistor RS is also required to be large in size and high in accuracy for reasons similar to those with the above-mentioned charging current detection resistor R1.

Thus, in the known power supply circuit or the like, two resistors for detecting electric currents separately or independently are arranged in series with each other in a single closed circuit that acts as a charging current supply line upon charging of the rechargeable battery, as a consequence of which there will be caused a lot of waste in space, cost and electric power.

### SUMMARY OF THE INVENTION

The present invention has been made in view of the above-mentioned problems, and has its object to provide a power supply circuit, a charger, a charging control circuit, an information processing device, and a battery pack which can reduce electric current detection resistors at a charger side thereby to achieve improvements in the charging efficiency of a power supply circuit or the like as well as reduction in cost and size.

In order to solve the above-mentioned problems, according to a first aspect of the present invention, there is provided a charging control circuit of a charging circuit capable of supplying a charging current to a rechargeable battery received in a battery pack. The charging control circuit comprises: a charging current detecting part that detects information on a charging current based on a potential difference generated by the charging current across opposite ends of a resistor arranged in the battery pack; and a control part that controls the charging current based on the information on the charging current. Preferably, the charging circuit is provided with a comparator for determining, based on the potential difference, whether an electric current flowing through the resistor is in a prescribed range. Preferably, the control part further controls a charging voltage to the battery based on the charging voltage. Preferably, the control part comprises a pulse width modulator. Preferably, the charging control circuit comprises a semiconductor device.

According to a second aspect of the present invention, there is provided a charging circuit capable of supplying a charging current to a rechargeable battery received in a battery pack. The charging circuit comprises: a charging current supply part connected with a charging current supply line for supplying a charging current to the charging current supply line; and a charging control circuit that controls the charging current supplied by the charging current supply part based on a potential difference generated by the charging current across opposite ends of a resistor arranged in the battery pack. Preferably, the charging current supply part has a switch connected with the charging current supply line for opening and closing the charging current supply line, and the charging control circuit controls the opening and closing of the switch based on the potential difference generated by the charging current across the opposite ends of the resistor arranged in the battery pack. Preferably, the charging control circuit controls the opening and closing of the switch further based on a charging voltage. Preferably, the charging circuit further comprises: a choke coil connected with the charging current supply line; and a flywheel synchronous rectifier switch also connected with the charging current supply line. The charging control circuit further controls the synchronous rectifier switch.

According to a third aspect of the present invention, there is provided a charger adapted to be connected with a rechargeable battery received in a battery pack for charging the battery. The charger comprises: a first connection terminal adapted to be connected with a positive terminal side of the battery for supplying a charging current to the battery; a second connection terminal adapted to be connected with a negative terminal side of the battery for supplying a charging current to the battery; a third connection terminal adapted to be connected with a prescribed external connection terminal of the battery pack, the third connection terminal being given a prescribed potential based on an electric current flowing through the battery; and a charging circuit connected with the third connection terminal and at least one of the first connection terminal and the second connection terminal for controlling the charging current supplied to the battery by detecting a potential difference based on an electric current flowing through the battery. Preferably, the charging circuit is further connected with the first connection terminal for controlling a charging voltage applied to the battery based on a potential at the first connection terminal. Preferably, the potential difference is a potential difference based on an electric current flowing through a resistor arranged in the battery pack. Preferably, the resistor is connected in series with the negative terminal side of the battery; the second connection terminal is connected with a far-from-battery side terminal of the resistor, and the third connection terminal is connected with a battery side terminal of the resistor and at the same time with a power supply through a prescribed resistor. Preferably, the charger further comprises a connection state determination part that compares a potential at the third connection terminal with a prescribed potential thereby to determine the connection state of the battery pack based on a result of the comparison.

According to a fourth aspect of the present invention, there is provided a power supply circuit comprising: a rechargeable battery; a resistor connected in series with the battery; a protection circuit that monitors a power supply electric current supplied from the battery based on a potential difference across opposite ends of the resistor; and a charger that applies a charging voltage to the battery thereby to supply a charging current thereto, the charger being operable to control the charging current supplied to the battery based on at least the potential difference across the opposite ends of the resistor. Preferably, the charger further controls the charging voltage based on the charging voltage applied to the battery. Preferably, the charger controls the charging current based on the potential difference across the opposite ends of the resistor in such a manner that the charging current is held at a value equal to or less than a predetermined value. Preferably, the battery, the resistor and the protection circuit are arranged in a battery pack having the battery received therein.

According to a fifth aspect of the present invention, there is provided an information processing device including a CPU installed thereon and a charger for charging a rechargeable battery, wherein the charger can introduce a potential difference which is generated across a resistor connected in series with the battery, due to a charging current through said resistor and which can be used to monitor the power supply electric current supplied from the battery, based on the potential difference across opposite ends of the resistor. The charging current supplied to the battery is controlled based on the potential difference across the opposite ends of the resistor. Preferably, the charger further controls the charging voltage based on the charging voltage applied to the battery.

According to a sixth aspect of the present invention, there is provided a battery pack having a rechargeable battery received therein, the battery pack comprising: a rechargeable battery; a first external connection terminal connected with a positive terminal side of the battery for receiving a charging current supplied thereto from outside as well as supplying electric power to external equipment; a second external connection terminal connected with a negative terminal side of the battery for receiving the charging current supplied thereto from outside as well as supplying electric power to external equipment; a resistor connected in series with the battery between the first external connection terminal and the second external connection terminal; a protection circuit that monitors an overcurrent state by detecting a potential difference across opposite ends of the resistor; and a third external connection terminal that supplies information on the potential difference across the opposite ends of the resistor to outside. Preferably, the information on the potential difference across the opposite ends of the resistor is potentials at the opposite ends of the resistor corresponding to the charging current, and a potential difference between a potential at one end of the resistor and a potential at either one of the first external connection terminal and the second external connection terminal indicates the potential difference across the opposite ends of the resistor.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a block diagram showing a power supply circuit according to the present invention.

FIG. 2 is a block diagram showing an information processing device according the present invention.

FIG. 3 is a block diagram of a known power supply circuit.

FIG. 4 is a view showing details of a part of FIG. 3.

### DESCRIPTION OF THE PREFERRED EMBODIMENT

Now, a preferred embodiment of the present invention will be described in detail while referring to the accompanying drawings.

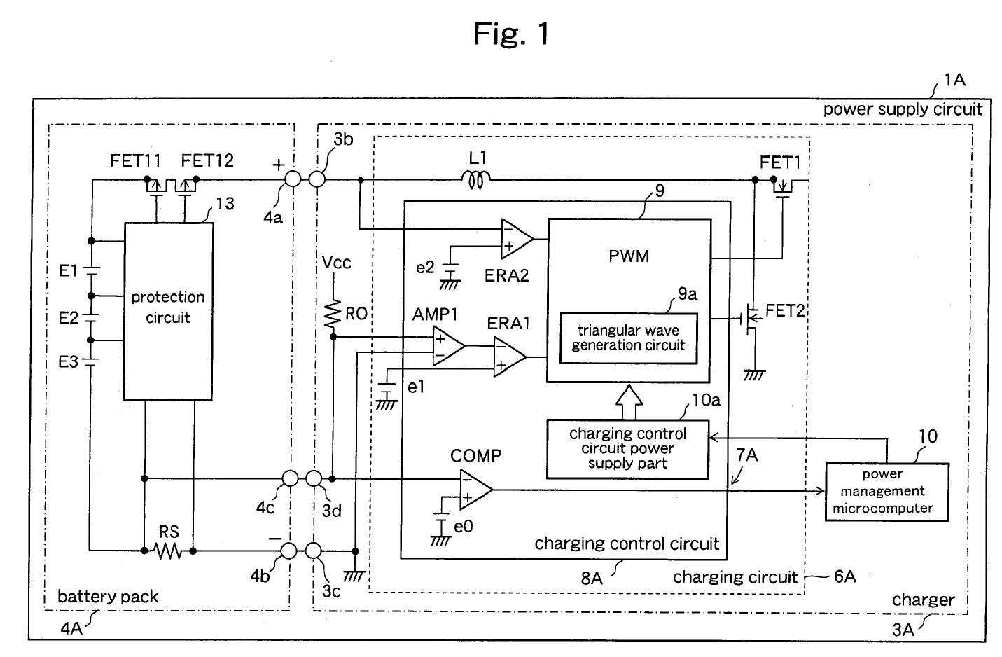

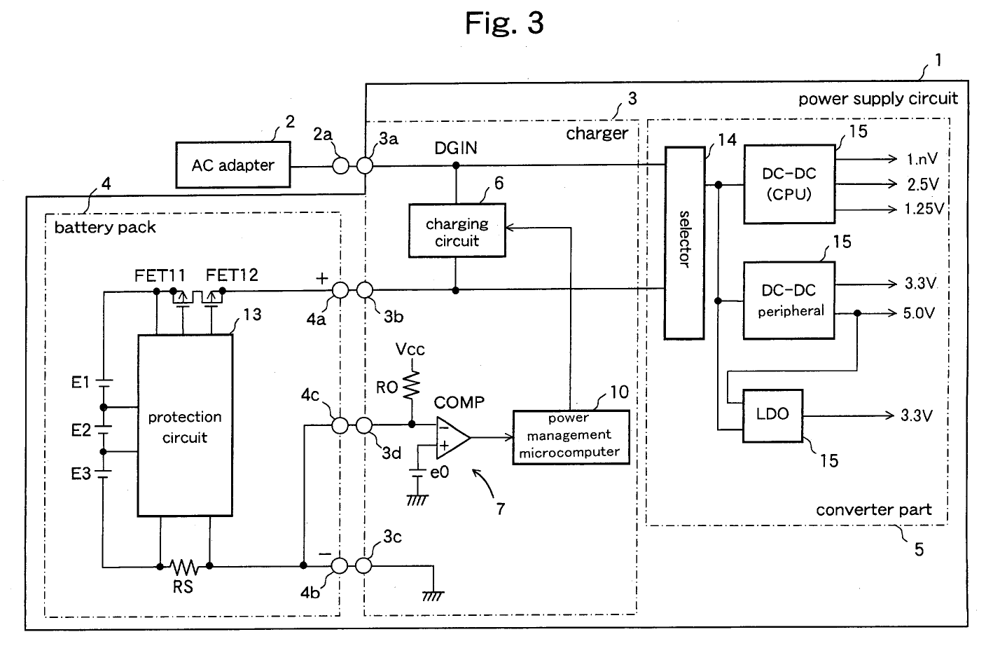

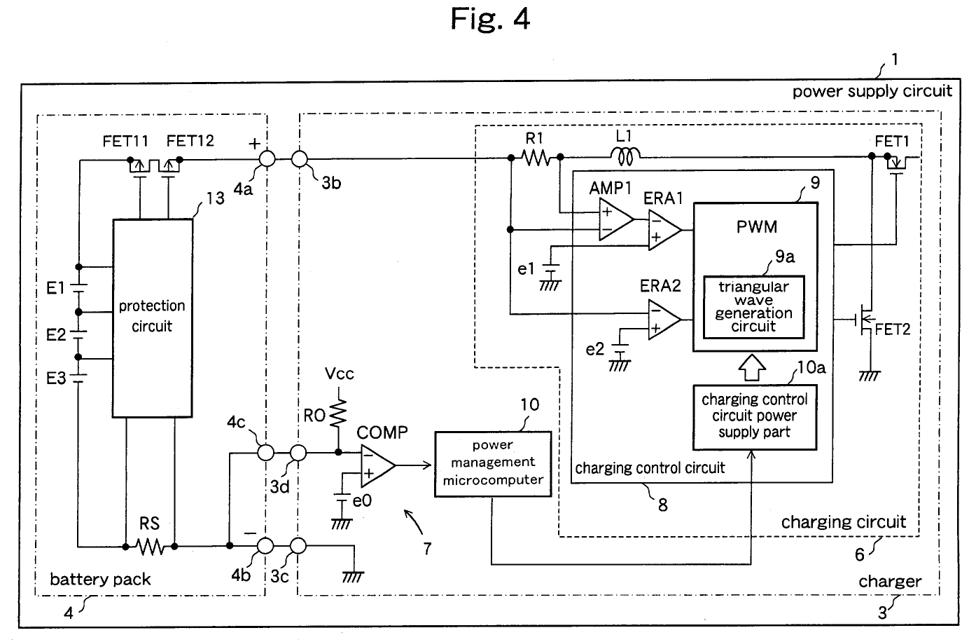

Hereinafter, reference will be made to the case where the present invention is applied to a PC (personal computer) system as an example of an information processing device. FIG. 1 is a block diagram that shows the PC system according to one embodiment of the present invention in comparison with the known power supply circuit illustrated in FIG. 4. In FIG. 1, the same symbols as those in FIG. 3 and FIG. 4 designate the same or corresponding parts or elements, and a detailed description thereof is omitted. FIG. 1 is different from FIG. 4 mainly in that a current sensing resistor RS arranged in a battery pack can be used by a charging circuit in place of the known current detection resistance R1. To this end, the charging circuit is constructed such that it can draw in a voltage drop due to the current sensing resistor RS (i.e., a potential difference at opposite ends of the current sensing resistor). In addition, in the battery pack, the current sensing resistor RS is connected at its battery side terminal with a third external connection terminal 4c. Hereinbelow, these will be explained in detail.

A power supply circuit 1A shown in FIG. 1 is provided with a charger 3A adapted to be connected with an AC adapter for obtaining a DC power supply for charging, and a battery pack 4A connected with the charger 3A and having a rechargeable battery comprising battery cells E1, E2 and E3.

The charger 3A is provided, as connector terminals, with a first connection terminal 3b connected with a positive terminal side of the rechargeable battery, and a second connection terminal 3c and a third connection terminal 3d connected with a negative terminal side of the rechargeable battery. In addition, the charger 3A is provided with a charging circuit 6A connected between an unillustrated power supply input terminal (see 3a in FIG. 3) and the first connection terminal 3b, a power management microcomputer 10 and a resistor R0 that together constitute a part of a connection state determination part 7A. The second connection terminal 3c is connected with the earth and with an inverting input terminal of a first comparator AMP1.

The charging control circuit 6A includes a switching transistor FET1 and a choke coil L1 both connected in series to a charging current supply line formed between an unillustrated power supply input terminal (see 3a in FIG. 3) and the first connection terminal 3b, a charging control circuit 8A for turning on and off the switching transistor FET1 thereby to charge the rechargeable battery within a prescribed voltage range and within a prescribed current range, and a flywheel synchronous rectifier switch in the form of a transistor FET2 for discharging the electric power of the choke coil L1. The charging circuit 6A does not include the charging current detection resistor R1 shown in FIG. 3, the function of which is, however, performed by the current sensing resistor RS in the battery pack 4A.

The charging control circuit 8A includes a first comparator AMP1 in the form of a voltage amplifier formed of a semiconductor as one chip for obtaining a potential difference between potentials at the opposite ends of the current sensing resistor RS, a second comparator ERA1 in the form of a current control error amplifier for comparing the potential difference obtained by the first comparator AMP1 with a first prescribed potential, a third comparator ERA2 in the form of a voltage control error amplifier for comparing a potential at the first connection terminal 3b side of the choke coil L1 with a second prescribed (reference potential) potential e2, a PWM (pulse width modulator) 9 for controlling to turn on and off the switching transistor FET1 based on the comparison results of the second comparator ERA1 and the third comparator ERA2 in such a manner that the charging voltage and the charging current are held within the prescribed voltage range and the prescribed current range, respectively, a comparator COMP that constitutes a part of the connection state determination part 7A, and a charging control circuit power supply part 10a for supplying electric power to the charging circuit 6A. As is well known, the PWM 9 is provided with a triangular wave generation circuit 9a in the form of a triangular wave oscillator. With the above configuration, the second comparator ERA1 outputs a low voltage when the electric current flowing through the current sensing resistor RS exceeds a predetermined allowable value, and outputs a high voltage when the predetermined allowable value is not exceeded.

As described above, the connection state determination part 7A is provided with the comparator COMP for comparing the potential at the third connection terminal 3d with the prescribed potential (reference potential) e0, the power management microcomputer 10 for determining the comparison result of the comparator COMP, and the resistor R0 connected between the third connection terminal 3d and the power supply voltage Vcc. Here, note that the comparator COMP is formed inside the charging control circuit 8A, but it may instead be arranged outside the charging circuit 6A in the charger 3A as in the above-mentioned prior art. Further, in cases where the charging control circuit 8A is formed of a semiconductor device, as described above, if the connection state determination part 7A is also formed into the semiconductor device, they can be fabricated integrally, thus providing an excellent effect of reducing the manufacturing cost and the size of the entire system.

The battery pack 4A is provided with a first external connection terminal (+ terminal) 4a, a second external connection terminal (− terminal) 4b, and a third external connection terminal (attaching/detaching detection terminal) 4c, which are connected with the first through third connection terminals 3b-3d, respectively, of the charger 3A. The switching transistors FET11, FET12, the battery cells E1, E2, E3 of the rechargeable battery and the current sensing resistor RS are connected in series between the first external connection terminal 4a and the second external connection terminal 4b. In addition, the third external connection terminal 4c is connected with a rechargeable battery side terminal of the current sensing resistor RS. Here, note that the battery pack 4A is provided with a protection circuit 13, as in the case of the battery pack 4 shown in FIG. 4.

Now, reference will be made to the operation of this embodiment of the present invention.

When the battery pack 4A is installed onto or attached to the charger 3A so that the charging circuit 6A in the form of a charging DC-DC converter is operated, an output current of the charging circuit 6A flows into the battery pack 4A through the first connection terminal 3b of the charger 3A and the first external connection terminal (+ terminal) 4a of the battery pack 4A. Further, the charging current returns to the second connection terminal 3c of the charger 3A while flowing through the battery cells E1, E2, E3 of the rechargeable battery, the current sensing resistor RS and the second external connection terminal (− terminal) 4b. In this manner, the charging of the rechargeable battery is carried out. The output voltage of the charging circuit 6A is detected as the potential of the first connection terminal 3b (i.e., the potential of the first external connection terminal 4a), as in the prior art, which is then compared with the reference voltage e2 and amplified to contribute to the formation of a PWM control signal.

On the other hand, the first comparator AMP1 in the form of the voltage amplifier detects and amplifies a voltage drop (potential difference) due to the electric current flowing through the current sensing resistor RS in the battery pack 4A, so that it outputs a voltage proportional to the magnitude of the current flowing through the current sensing resistor RS. The second comparator ERA1 in the form of the current control error amplifier compares the current value detected by the current sensing resistor RS with a reference current value (potential e1), which is given as a voltage value, thereby to amplify it. The first comparator ERA1 outputs a low voltage to the PWM 9 when the electric current flowing through the current sensing resistor RS is larger than the reference current value, whereas it outputs a high voltage to the PWM 9 when the electric current is less than the reference current value.

The PWM 9 is a voltage comparator having a plurality of non-inverting inputs and one inverting input, the voltage comparator being in the form of a voltage pulse width converter for controlling an on (high) time of the width of an output pulse thereof in accordance with an input voltage thereto. The triangular wave (not shown herein) from the triangular wave generation circuit 9a in the form of the triangular wave oscillator turns on the switching transistor (main switch) FET1 during the period when both of the output voltages of the current control error amplifier ERA1 and the voltage control error amplifier ERA2 are low.

Though in this embodiment, the voltage Vcc is applied through the resistor R0 to the non-inverting input side of the first comparator AMP1 that amplifies the voltage drop of the current sensing resistor RS, the influence of this connection can be substantially disregarded. In general, the voltage Vcc is 5.0 V or 3.3 V. Moreover, the resistance value of the resistor R0 is a termination resistance value for providing a high voltage when the battery pack 4A is disconnected from the comparator COMP, and hence it is set to a value of 10 KΩ or more. On the other hand, a large current flows through the current sensing resistor RS, so the resistance value thereof is set to about 10 mΩ to about 20 mΩ. A voltage appearing at the third connection terminal 3d of the charger 3A (or the third external connection terminal 4c of the battery pack 4) when a voltage of 5.0 V is applied to the series resistors of 10 KΩ and 20 mΩ is 0.02/(0.02+10000)×5.0=9 μV, and hence it can be completely disregarded.

Next, reference will be made to the operation of the system upon occurrence of abnormality such as the battery pack 4A being inadvertently pulled out from the charger 3A during the operation of the charging control circuit 8A. In general, the output voltage of the charger 3A is controlled so that a constant current flows into the battery pack 4A, but when the battery pack 4A is pulled out, the charging current becomes zero and hence the charging control circuit 8A operates to increase the output voltage of the charger 3A in order to increase the charging current. In this embodiment, however, the inverting input of the first comparator (i.e., voltage amplifier) AMP1 for detecting the electric current flowing through the current sensing resistor RS is connected with the second connection terminal 3c of the charger 3A (i.e., the second external connection terminal (− terminal) 4b of the battery pack 4A), and the non-inverting input of the first comparator AMP1 is connected with the third connection terminal 3d (i.e., the third external connection terminal 4c). Accordingly, when the battery pack 4A is removed from the charger 3A, the voltage at the third connection terminal 3d is raised to Vcc to increase the output voltage of the voltage amplifier AMP1, thus making the system in the same state as the case where there is an excessive charging current flowing through the charger 3A. As a result, the first comparator (i.e., current control error amplifier) ERA1 acts on the PWM 9 so as to decrease the output current of the charger 3A, whereby the output voltage of the charger 3A falls to almost near 0 V.

Here, note that the protection circuit 13 serves to prevent deterioration of the battery function owing to misoperation or unauthorized operation by the user. That is, the protection circuit 13 interrupts the output of the battery by detecting when the voltage of the battery falls equal to or below a specified voltage. Deterioration of the battery function due to the user's misoperation or unauthorized operation becomes remarkable particularly in cases where a lithium ion (Li+) rechargeable battery, an NiMH battery or the like is used as the rechargeable battery E1, E2 and E3. Unlike NiCad batteries, these batteries are vulnerable to overdischarging, and might be subject to unrecoverable damage when mistakenly overdischarged by the user. The system according to this embodiment is constructed in consideration of these facts, too.

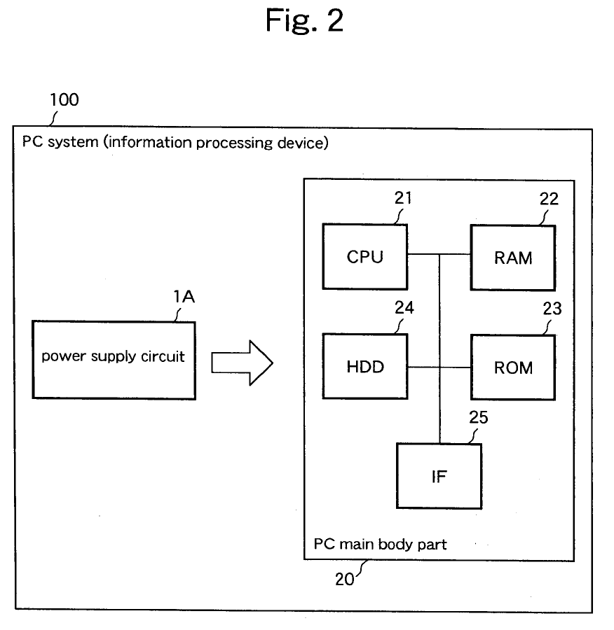

The power supply circuit 1A explained in this embodiment can be applied to an information processing device (PC system) 100 for instance, as shown in FIG. 2, which can be used as portable electronic equipment such as a personal computer, a mobile phone, a PDA (personal digital assistant), etc. The information processing device 100 shown in FIG. 2 is provided with the above-mentioned power supply circuit 1A and a PC main body part 20, and the PC main body part 20 includes a CPU 21, a RAM 22, a ROM 23, a HDD 24 and an interface (IF) 25.

As described in the foregoing, it is possible to omit or remove the current detection resistance R1 of the known charger 3 merely by changing connections of electric circuitry so as to share the current sensing resistor RS incorporated in the battery pack 4A with the charger 3A side while maintaining the basic operation of the entire system without any change. Therefore, the efficiency of the charger 3A is improved, the cost is reduced, and the charger 3A is miniaturized. It is to be noted that the present invention is not limited to this embodiment. For instance, in this embodiment, the circuit configuration of the charger 3A has been described as the DC-DC converter of the switching regulator type, but it is needless to say that the present invention is also applicable to DC-DC converters of the linear regulator type.

As described above in detail, the present invention can achieve the following advantageous effect. That is, a current sensing resistor at a charger side can be omitted, so that it is possible to provide a power supply circuit, a charger, a charging control circuit, an information processing device, and a battery pack which can achieve improvements in the charging efficiency of a power supply circuit or the like as well as reduction in cost and miniaturization of the charger.

While the invention has been described in terms of a preferred embodiment, those skilled in the art will recognize that the invention can be practiced with modifications within the spirit and scope of the appended claims.

What is claimed is:

1. A charging control circuit of a charging circuit capable of supplying a charging current to a rechargeable battery received in a battery pack,
said charging control circuit comprising:
a charging current detecting part that detects information on a charging current based on a potential difference generated by the charging current across opposite ends of a resistor arranged in said battery pack; and
a control part that controls the charging current based on said information on the charging current.

2. The charging control circuit as set forth in claim 1, wherein said charging circuit is provided with a comparator for determining, based on said potential difference, whether an electric current flowing through said resistor is in a prescribed range.

3. The charging control circuit as set forth in claim 1, wherein said control part further controls a charging voltage to said battery based on the charging voltage.

4. The charging control circuit as set forth in claim 1, wherein said control part comprises a pulse width modulator.

5. The charging control circuit as set forth in claim 1, wherein said charging control circuit comprises a semiconductor device.

6. A charging circuit capable of supplying a charging current to a rechargeable battery received in a battery pack,
said charging circuit comprising:
a charging current supply part connected with a charging current supply line for supplying a charging current to said charging current supply line; and
a charging control circuit that controls the charging current supplied by said charging current supply part based on a potential difference generated by the charging current across opposite ends of a resistor arranged in said battery pack.

7. The charging circuit as set forth in claim 6, wherein
said charging current supply part has a switch connected with said charging current supply line for opening and closing said charging current supply line; and
said charging control circuit controls the opening and closing of said switch based on the potential difference generated by the charging current across the opposite ends of said resistor arranged in said battery pack.

8. The charging circuit as set forth in claim 7, wherein said charging control circuit controls the opening and closing of said switch further based on a charging voltage.

9. The charging circuit as set forth in claim 7, further comprising:
a choke coil connected with said charging current supply line; and
a flywheel synchronous rectifier switch also connected with said charging current supply line;
wherein said charging control circuit further controls said synchronous rectifier switch.

10. A charger adapted to be connected with a rechargeable battery received in a battery pack for charging said battery,
said charger comprising:
a first connection terminal adapted to be connected with a positive terminal side of said battery for supplying a charging current to said battery;
a second connection terminal adapted to be connected with a negative terminal side of said battery for supplying a charging current to said battery;
a third connection terminal adapted to be connected with a prescribed external connection terminal of said battery pack, said third connection terminal being given a prescribed potential based on an electric current flowing through said battery; and
a charging circuit connected with said third connection terminal and at least one of said first connection terminal and said second connection terminal for controlling the charging current supplied to said battery by detecting a potential difference based on an electric current flowing through said battery.

11. The charger as set forth in claim 10, wherein said charging circuit is further connected with said first connection terminal for controlling a charging voltage applied to said battery based on a potential at said first connection terminal.

12. The charger as set forth in claim 10, wherein said potential difference is a potential difference based on an electric current flowing through a resistor arranged in said battery pack.

13. The charger as set forth in claim 12, wherein
said resistor is connected in series with the negative terminal side of said battery;
said second connection terminal is connected with a far-from-battery side terminal of said resistor; and
said third connection terminal is connected with a battery side terminal of said resistor and at the same time with a power supply through a prescribed resistor.

14. The charger as set forth in claim 13, further comprising a connection state determination part that compares a potential at said third connection terminal with a prescribed potential thereby to determine the connection state of said battery pack based on a result of the comparison.

15. A power supply circuit comprising:
a rechargeable battery;
a resistor connected in series with said battery;
a protection circuit that monitors a power supply electric current supplied from said battery based on a potential difference across opposite ends of said resistor; and
a charger that applies a charging voltage to said battery thereby to supply a charging current thereto, said charger being operable to control the charging current supplied to said battery based on at least the potential difference across the opposite ends of said resistor.

16. The power supply circuit as set forth in claim 15, wherein said charger further controls the charging voltage based on the charging voltage applied to said battery.

17. The power supply circuit as set forth in claim 15, wherein said charger controls the charging current based on the potential difference across the opposite ends of said resistor in such a manner that said charging current is held at a value equal to or less than a predetermined value.

18. The power supply circuit as set forth in claim 15,- wherein said battery, said resistor and said protection circuit are arranged in a battery pack having said battery received therein.

19. An information processing device including a CPU installed thereon and a charger for charging a rechargeable battery, wherein
said charger can introduce a potential difference which is generated across a resistor connected in series with the battery, due to a charging current through said resistor and which can be used to monitor the power supply electric current supplied from said battery, based on the potential difference across opposite ends of said resistor; and
said charging current supplied to said battery is controlled based on the potential difference across the opposite ends of said resistor.

20. The information processing device as set forth in claim 19, wherein said charger further controls the charging voltage based on the charging voltage applied to said battery.

21. A battery pack having a rechargeable battery received therein,
said battery pack comprising:
a rechargeable battery;
a first external connection terminal connected with a positive terminal side of said battery for receiving a charging current supplied thereto from outside as well as supplying electric power to external equipment;
a second external connection terminal connected with a negative terminal side of said battery for receiving the charging current supplied thereto from outside as well as supplying electric power to external equipment;
a resistor connected in series with said battery between said first external connection terminal and said second external connection terminal;
a protection circuit that monitors an overcurrent state by detecting a potential difference across opposite ends of said resistor; and
a third external connection terminal that supplies information on the potential difference across the opposite ends of said resistor to outside.

22. The battery pack as set forth in claim 21, wherein
said information on the potential difference across the opposite ends of said resistor is potentials at the opposite ends of said resistor corresponding to said charging current, and
a potential difference between a potential at one end of said resistor and a potential at either one of said first external connection terminal and said second external connection terminal indicates said potential difference across the opposite ends of said resistor.
